(19) United States
(12) Patent Application Publication
(10) Pub. No.: US 2005/0010652 A1
(43) Pub. Date: Jan. 13, 2005

(54) Process and device for selective download of data based on index file transmitted from a central server

(75) Inventor: Paul Lebrun, Le Bar Sur Loup (FR)

Correspondence Address: YOUNG & THOMPSON, 745 SOUTH 23RD STREET, 2ND FLOOR, ARLINGTON, VA, 22202, US

(73) Assignee: IDEOGRAM DESIGN S.A.R.L., VALBONNE (FR)

(21) Appl. No.: 10/911,506

(22) Filed: Aug. 5, 2004

Related U.S. Application Data
(63) Continuation of application No. 09/582,098, filed on Jun. 22, 2000, now abandoned.

(51) Int. Cl. G06F 15/16

(52) U.S. Cl. 709/219

(57) ABSTRACT

Processes for the transmission and display of updated data from a central server to at least one subscriber station, via a digital communication network, in which each subscriber can connect his station to the server. The device according to the invention comprises a central server (1) containing data, a digital communication network (2) for the transfer of data from the server (1) to at least one subscriber station (3), at least one subscriber station (3) constituted by a storage system (4) for the data already transmitted by the server (1) and recorded and a comparison system (5) for the transmitted and stored data, a digital disc reader (6), per station (3), and this means for simultaneously displaying stored data and information from the disc at the station (3).

### CROSS REFERENCE TO RELATED APPLICATIONS

This application is a continuation of co-pending application Ser. No. 09/582,098, filed on Jun. 22, 2000. application Ser. No. 09/582,098 is the national phase of PCT International Application No. PCT/FR97/02372 filed on Dec. 22, 1997 under 35 U.S.C. § 371. The entire contents of each of the above-identified applications are hereby incorporated by reference.

### BACKGROUND OF THE INVENTION

The present invention has for its object, on the one hand, processes for the transmission and display of data and, on the other hand, devices for practicing such processes.

The document FR-A-2.648.299 suggests a process and devices for transmitting to subscriber stations on a high flow digital telecommunication network, from a central server, information recorded in a collection of digital discs. A device according to the invention comprises a central server connected by an interface to a digital telecommunication network to which are connected subscriber stations. The central server comprises a central computer, a store of digital discs, optical reading platforms for the discs and means for transferring discs between the store and the reading platform, particularly a conveyor and a handling device controlled by a robot itself controlled by the central computer.

EP-A-0 646 856: A device for researching information displays portions of a document dynamically modifiable required by the user. The device has a controller connected to a display screen, input selection switches such as buttons, and a memory such as a non-volatile flash memory. One or several documents, such as a newspaper or a magazine, are stored in the memory, a receiver such as a call device, a modem or FM radio receiver, is connected to the memory to update it. When the device is illuminated, a first portion of a document is displayed on the display screen. When the user desires to see another portion of the document, or another document, he presses one of the buttons. According to the detection of the pressure on the button, an action takes place and changes the display on the screen. The action that is caused can vary in complexity: it can drive the display of the following page of the document, or can execute an internal hypertext connection such that information contained in the same document, or another document, will be displayed as to only a portion of the display screen. The document is stored in the memory so as to permit the display screen to be renewed directly from the memory. When a portion of a displayed document is received by the receiver, this portion of the memory is displayed.

This patent describes the use of piling or bundling documents, then several bundles of the document are modified.

According to the invention, it is thanks to the indexed file that there is a comparison. It is after the comparison that there is if desired a single teleloading (downloading) of what is modified.

IEEE Journal on selected area in communication, vol. 3, No. 3, May 1985, New York USA, pages 457-467, XPOO2041125, D. K. GIFFORD et al.: “The application of digital broadcast communication to large scale information systems”, paragraph I, paragraph II: this document describes a process permitting teleloading a new version every four hours or when necessary.

The process according to the invention seeks exactly to avoid this type of problem.

In this document, the assembly of the data is carried by the digital discs. It will be necessary that each subscriber carry out the teleloading on his station, of the complete contents of the disc or discs which interest him. The communications take place by the telephone network, if the distance between the server and the subscriber station is great, the financial cost would be prohibitive. Moreover, the data, which can be confidential, are transmitted by a single network, because of this, the protection is not always assured.

There is known from the document EP-A-0 460 869 a system of data access, a display apparatus and a method for recordation and display. In this document, a personal computer comprises a data base and a CD-ROM adapted to supply images for their display. The database contains itself details relating to these images. The database can be obtained from a manufacturer by communication by modem.

In addition to the particular application to illustrated images, this document does not ensure updating the data by a comparison between the data of the manufacturer and those of the base.

U.S. Pat. No. 5,347,632 provides an interactive computer network which permits a user to display the desired information. According to a modification, this document provides a verification of the files at the disposal of the user, by comparison with the data of the network.

It appears from the text itself of this document that this verification greatly increases the working time necessary for the display of the desired data. This verification would be very detrimental to the speed of the system.

The technical progress of communications and their access in the greatest number have led to a considerable increase of the transfer of information in digital format. Without extrapolating toward the physical limits of the number of emissions possible by radio-electric waves or cables, the simple commercial requirement for operators of networks to show a profit on their investment leads one to suppose that the cost of use of the networks will be or will remain proportional to the quantity of data transferred. For an equal transfer speed, it will be proportional to the use time.

### SUMMARY OF THE INVENTION

In this context, the present invention will be seen as a judicious alternative to minimize the quantity of information to be transferred, whilst maintaining the advantage of having the most recent information. This system provides for the final user an optimization of the speed of display of the information, on the one hand, and an important saving of time necessary for a program to decide the choice of acquisition of new data or the use of existing data, and on the other hand, not loading new data unless necessary.

The present invention deals with two processes and two devices for practicing these processes, which are of very low cost of operation, and whose installation is easy, and which have a better level of security.

To do this, certain information which is not modifiable is inscribed on a digital disc associated with a reader at a subscriber station. The server, for its part, comprises several modifiable data which can be transmitted toward each station, upon the demand of the subscriber in question, so that a display will be possible at the station of said subscriber, on the one hand, of information carried by the disc and, on the other hand, of the transmitted data.

As a result, the cost of operation is low and security is absolute because only a small portion of the data and information displayed pass via the network.

To this end, and according to a first mode of operation, the invention relates to a process for the transmission and display of data regularly displayed from a central server and directed toward at least one subscriber station, via a digital communication network, wherein each subscriber who desires to know the displayed data, connects his station to the server, characterized in that the server ensures the automatic transmission of the digital data toward said station at which software permits:
comparing the data precedingly stored in a memory, to the new transmitted data,
not recording the available data on the server if the stored data are identical, or activating the transmission and recordation of said data in lieu of and in place of said stored data if the latter are different,
simultaneously displaying the recorded and stored data and the principal information from the reading of a digital disc, a diskette or the like associated with the subscriber station.

According to a second mode of operation, the invention relates to a process for the transmission and display of data regularly updated from a central server and destined for at least one subscriber station, via a digital communication network, wherein each subscriber who desires to know the available data, connects his station to the server, characterized in that the server ensures the automatic transmission of the digital data toward said station at which software permits displaying simultaneously the transmitted data and the information from the reading of a digital disc, from a diskette or the like, associated with the subscriber station.

According to another embodiment, a file labeled “index” is used. Initially, the data are recorded on a magnetic, optical or magneto-optical support.

The new data, on a distant server, are regularly updated by the editor of the content of the supports.

The distance server comprises a file labeled “index”, comprising information relative to the version of the computer supports compatible with the data available on the server, in the name and at the place of the available files, and their characteristics (date and size in octets).

During reading of the application present on the computer support, the program carries out a first connection with the server and loads the “index” file.

The latter comprises only minimum information and is hence teleloaded very rapidly.

Then the program compares the information contained in this “index” file and the information on the files present locally on the computer storage support or supports of the user. If it appears that the file present on the server is more recent than the local file or that the local file has been modified, the program then carries out an updating of the file by telecharging the one present on the server.

The fineness of the updating depends on the frequency of loading of the “index” file. The latter can be triggered automatically according to a calendar, a delay or the request of the user.

This technique is particularly interesting in the framework of updating with a known periodicity, greatly superior to the time necessary for a complete transfer of the files of the server toward the user.

Contrary to the web technique in which the user must seek the information that he desires to acquire, the process according to the invention permits the editor of the initial program to decide himself the files to update and at what time.

According to another embodiment of the process, the “index” file of the server is automatically generated during connection of a user with a program present on the server.

The “index” file also comprises the date of the next modification of the files present on the server.

The information is recorded on the same support as the one containing the initial application (reinscribable CD).

The invention also relates to a device permitting the practice of the process, according to the first mode of operation, which is characterized by the fact that it comprises:
a central server containing regularly updated data,
a digital communication network for the transfer of the data from the server to at least one subscriber station,
at least one subscriber station, each station being constituted, on the one hand, by a system of storage of an index file comprising data already transmitted by said server and recorded and, on the other hand, by a system for the comparison of an index file containing the data available on the server and the indexed file containing the data recorded or stored so as to preserve the stored data, if there are no modifications in the transmitted indexed files, or to carry out the teleloading and replace the stored data by data available at the files indexed on said server, transmitted if there were modifications,
a reader of digital discs, diskettes or the like for each subscriber station, and
means for displaying simultaneously indexed files containing stored data and information of the disc, the diskette or the like, by subscriber station.

The invention also relates to a device permitting the practice of the process, according to the second embodiment of operation, which is characterized by the fact that it comprises:
a central server comprising regularly updated data,
a digital communication network for transferring data from the server toward at least one subscriber station,
at least one subscriber station,
a reader of digital discs, of diskettes or the like, for each subscriber station, and
means for displaying simultaneously the data transmitted and the information on the disc, on the diskette or the like, by subscriber station.

No matter what the embodiment of the device, the communication network used is the telephone network.

Moreover, the subscriber station is a personal computer, the reader and the digital disc are constituted by a compact optical disc with a laser reader, and the display means is a screen.

On the one hand, the digital disc comprises non-modifiable information of which certain spaces provided for this purpose are blank, on the other hand, the stored data are adapted to be emplaced in these spaces during display.

### BRIEF DESCRIPTION OF THE DRAWINGS

The accompanying drawings are given by way of indicative and non-limiting examples. They show two embodiments according to the invention. They permit easy comprehension of the invention.

FIG. 1 is a schematic view of the device according to a first embodiment of the invention, to permit practicing the first operating mode of the process.

FIG. 2 is a schematic view of the device according to a second embodiment of the invention, to permit practicing a second mode of operation of the process.

### DESCRIPTION OF THE PREFERRED EMBODIMENTS

The present invention relates to two processes for the transmission and display of data as well as two devices permitting carrying them out.

According to FIG. 2, a simplified embodiment of the device according to the invention is shown.

The latter comprises essentially a central server 11 which is located remotely from a subscriber station 13. The server 11 and the subscriber station 13 are connected to each other by the communication network 12, which can be also constituted by a telephone network.

Of course, the server 11 could be connected with a very great number of subscriber stations 13. To facilitate comprehension, a single station 13 has been shown in the figures.

Each station 13 is constituted by a reader 16 of digital discs, each digital disc comprising, on the one hand, information 17 and, on the other hand, free spaces 18 to permit the reception of data from the server 11.

It is thus evident that this system could be used by companies which produce, resell or have a distribution network. If these enterprises wish to place an electronic link at the disposal of the dealers, the system according to the invention will be quite suitable. It will permit ensuring commercial service, by permitting maintaining a permanent presence, which commercial personnel cannot ensure. It permits on the other hand, by its network, rapid and reliable commands, which contrast with the previous techniques of telephonic contact which require a standard and a storage of the commands by telecopy. Moreover, the system also permits ensuring after-sale service by updating the technical files and by the control of the pieces in a simplified manner.

Thus, if a dealer needs to know the price of material or of promotions which relate to certain products in a catalog, he could read from the digital disc to have general information of the catalog, as for example presentation, references, figures, etc. The server 11 by means of the network 12 will transmit the data which are not present in the digital disc. These could be values which are often changed, as for example the price, the quantities in stock, or whether the article is the object of a promotion.

The process for transmission and display, according to the invention, will therefore permit, on the screen of the dealer, having an up-to-date document comprising on the one hand information carried by the digital disc, which are fixed, and on the other hand, the data from the server 11, which themselves are variable but which always will be updated.

It follows from this that the time of connection between the subscriber station 13 and the server 11 will be minimized by transmission only of the variable data. The cost of this will be very low, and the transmitted data not being connected with the information of the digital disc, will be quite secure because they will be incomprehensible for anyone who could come upon them, in the absence of the information on the compact disc.

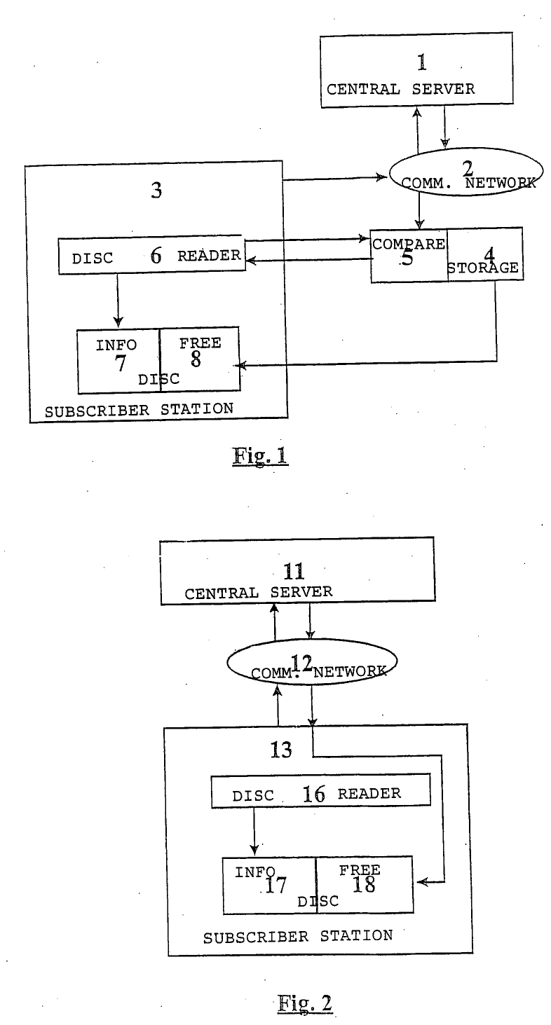

According to FIG. 1, the embodiment of the device can be a bit more complex to ensure even more satisfactory performance.

According to this modification, between the server 1 and the subscriber station 3 are added at said station 3, on the one hand, a storage system 4 for data and, on the other hand, a comparison system 5 for the stored data relative to the transmitted data.

In this embodiment, the dealer, at the station 3, will connect himself to the server 1 via the digital communication network 2. The server 1 will then transmit the data concerning the files which it has, via the digital network 2, to the comparison system 5 of the subscriber station 3. At this comparison system 5 are already stored the previously received data. If the data concerning the files available on the server and those of the stored files are identical, there is no change in the stored data. By contrast, if the received data show a change relative to the stored data, the new data will be teleloaded and will replace the previous stored data. This storage takes place in the system 4.

As in FIG. 1, each station 3 is constituted by a reader 6 of digital discs, each digital disc comprising, on the one hand, information 7 and, on the other hand, free spaces 8 to permit the reception of data from the server 1.

When the dealer wishes to study the catalog of his supplier, it will suffice that he read on the screen the information from the disc 7 and the data which are stored in the storage system 4 and which will appear on the screen in the free spaces 8 of the digital disc.

Such a system permits enhancing the value of the products and services, satisfying the dealers and goods of various manufacturers, motivating the dealer network, updating very rapidly the assembly of variable data, controlling the stocks as rapidly as possible, having rapid information feedback, and finally minimizing the telephone services for sales and after-sales.

The technical objectives are the simplicity of an embodiment of the server and of the client systems, the control and ease of updating data, the multi-platform client compatibility, and the unlimited control of simultaneous connections.

Finally, the financial object is to minimize the cost of telecommunication, of using the server and of the formation and maintenance connected to the server.

As to the client, the latter will have abundant and reliable information, rapid access to this information, low cost of material necessary for connection, because this system is usable with a conventional personal computer, simplicity of use and finally reduction of the control time.

In a technical approach to the problem, it can be supposed that the product requires a code of eight characters and a product also of eight characters, adding to this eight characters for information as to size, color, etc. As a result, a product will correspond to 24 octets of data.

For a catalog of 10,000 articles, the quantity of information will therefore be 240,000 octets, or 234.3 Ko. Under these conditions and in the case of a current configuration permitting a connection of 2 Ko per second, the time of transfer for all the information will be very short, of the order of 100 seconds, and the number of articles updated will be very great.

1. A process for transmitting data from a central server to at least one subscriber station via a digital communication network in which the subscriber station has a memory storing first data files and information describing the first data files, wherein the first data files stored at the subscriber station are updated with second data files from the central server by the process comprising the steps of:
creating an index file at the central server, the index file including information describing the second data files;
transmitting the index file from the central server to the subscriber station without transmitting the second data files described therein;
at the subscriber station, comparing information in the received index file describing the second data files with information in the memory describing the first data files to determine which of the first data files are to be updated;
downloading from the central server to the subscriber station only ones of the second data files corresponding to the first data files which the comparing step has determined are to be updated; and
updating the corresponding first data files with the downloaded second data files.

2. The process of claim 1, wherein the index file is transmitted to the subscriber station automatically at each use of the memory.

3. The process of claim 1, wherein the index file is transmitted to the subscriber station automatically with a given periodicity.

4. The process of claim 1, wherein the index file is transmitted to the subscriber station upon demand of the subscriber.

5. The process of claim 1, further comprising the step of storing in the memory the second data files downloaded from the central server.

6. The process of claim 1, wherein the information contained in the index file describes at least one of version, name, position, size and data characteristics of the second data files.

7. The process of claim 6, wherein the index file includes a date of a next modification of the second data files.

8. The process of claim 1, wherein the memory is a portable memory device, and further comprising the step of recording in the portable memory device information from the received index file corresponding to the updated first data files.

9. A system for transmitting data from a central server to at least one subscriber station via a digital communication network in which the subscriber station has a memory storing first data files and information describing the first data files, wherein the first data files stored at the subscriber station are updated with second data files from the central server, the system comprising:
an index file at the central server, the index file including information describing the second data files;
a communication link through which the index file is transmitted from the central server to the subscriber station without transmitting the second data files described therein;
a comparator at the subscriber station that compares information in the received index file describing the second data files with information in the memory describing the first data files to determine which of the first data files are to be updated,
the subscriber station for downloading from the central server to the subscriber station only ones of the second data files corresponding to the first data files which the comparator has determined are to be updated, and updating the corresponding first data files with the downloaded second data files.
